(19) United States
(12) Patent Application Publication
(10) Pub. No.: US 2022/0008876 A1
(43) Pub. Date: Jan. 13, 2022

(54) SHAKING AND/ OR MIXING DEVICE

(71) Applicant: Hans Heidolph GmbH, Kelheim (DE)

(72) Inventors: Maximilian Bayer, Abenberg (DE); Frank Werner, Grafenberg (DE)

(73) Assignee: Hans Heidolph GmbH, Kelheim (DE)

(21) Appl. No.: 17/288,809

(22) PCT Filed: Oct. 24, 2019
(86) PCT No.: PCT/EP2019/079004

§ 371 Date: Apr. 26, 2021

(30) Foreign Application Priority Data
Oct. 24, 2018 (DE) 20 2018 004 940.9

(51) Int. Cl. B01F 11/00; B01F 15/00; F16D 1/116

(52) U.S. Cl. CPC B01F 11/0014; B01F 11/0008; B01F 15/0048; F16D 2001/102; F16D 1/116; B01F 2215/0037; B01F 2015/00084; B01F 15/00538

(57) ABSTRACT

A shaking and/or mixing device comprises: a drive (7a) having a drive shaft (7), an eccentric unit (4) driven by the drive shaft (7) and having an eccentric hub (14), and a holder (20) for receiving at least one sample to be treated by the shaking and/or mixing device (1). The eccentric hub (14) and the holder (20) are connectable to one another by means of a releasable connection in order to transmit a movement of the eccentric hub (14) onto the holder (20) and the releasable connection is provided as an extension of the drive shaft (7).

The present invention relates to a shaking and/or mixing device and a coupling system for a shaking and/or mixing device. A shaking and/or mixing device, hereinafter referred to as a shaking and mixing device in a simplified manner, is a laboratory device which comprises a drive which drives an eccentric unit with an eccentric hub. The movement of the eccentric hub is transmitted to a sample holder on which the sample to be treated or the samples to be treated is or are provided in one or more sample containers. In this way, the sample container(s) is or are brought into periodic one-, two- or three-dimensional movements, such as e.g. rotating, vibrating, circular, tumbling and/or rocking movements. This leads to a mixing or a shaking and mixing of the sample(s).

Depending on the characteristics, in particular the geometric shape, of the sample containers or the sample container and the number of samples to be treated in the shaking and mixing device, various holders for sample containers are known from the state of the art. Usually, the holder is attached directly or indirectly, for example via a shaking table, to an outer circumference of the eccentric hub. However, due to the geometry of the eccentric hub, the attachment possibilities are limited and the provision of holders adapted to individual applications or sample containers is possible with considerable time and/or constructional and thus also cost-intensive effort.

The object of the present invention consists in providing an alternative or improved shaking and mixing device which, in particular, makes an easier exchange of the holder on which the sample container(s) is/are provided possible or makes the provision of different holders possible in a simple manner.

The object is solved by a shaking and mixing device according to claim 1. Further embodiments of the invention are given in the dependent claims.

A shaking and mixing device according to the invention comprises a drive having a drive shaft, an eccentric unit driven by the drive shaft and having an eccentric hub, and a holder for receiving at least one sample to be treated by the shaking and mixing device. The eccentric hub and the holder are connectable to one another by means of a releasable connection in order to transmit a movement of the eccentric hub onto the holder, wherein the releasable connection is provided as an extension of the drive shaft.

The drive is preferably an electric drive, for example a motor. The holder may be configured to hold one or more samples to be mixed, wherein each of the samples is provided in a sample container. By transmitting a movement of the eccentric hub to the holder, it is not necessarily meant that the holder performs the same movement as the eccentric hub, but that the movement of the eccentric hub causes a movement of the holder. For example, the movement of the holder may be a vibrating or oscillating movement.

In the context of the present application, a releasable connection is understood to be a connection that may be released again without damaging the components that are connected to each other by the releasable connection, i.e. the holder and the eccentric hub.

This makes it possible, for example, to effect mixing, i.e. shaking and mixing, of the sample(s) provided on the holder. The releasable connection between the holder and the eccentric hub makes it possible, for example, to use or attach to the shaking and mixing device a holder adapted to the particular intended use, i.e. a holder adapted to a geometric shape of one or more sample containers and/or to a number of samples to be treated. For example, a plurality of holders may be provided and a holder adapted to the particular application may be selected. Due to the releasable connection, the respective holder may be quickly and easily attached to the shaking and mixing device, i.e. one and the same shaking and mixing device may be used with different holders.

Preferably, a portion of the connection is provided as an adapter element that is attachable to the respective holder. In this way, it may be possible, for example, to provide the corresponding portion of the connection, also referred to as the coupling portion, only once and to use it with different holders, which may simplify the manufacture of the holder(s).

Preferably, the eccentric hub comprises a first coupling portion of the releasable connection and the holder comprises a second coupling portion of the releasable connection, wherein the first and the second coupling portions are designed at least partially complementary with respect to their geometric shape. In this way, for example, a constructively uncomplicated embodiment of a releasable connection for connecting the eccentric hub to the holder is provided.

Preferably, one of the two coupling portions comprises at least one bore and the other of the two coupling portions comprises at least one plug which can be inserted into the bore and which is designed complementary to the bore. In this way, the plug and the bore, or the two coupling portions, respectively, form a form-fit connection in radial direction (perpendicular to the central axis), i.e. a form-fit connection that prevents a rotation of the plug in the bore, or of the two coupling portions relative to each other, respectively. There may also be more than one cooperating bore-plug pair. By means of such a plug connection or plug coupling, i.e. a plug-bore pair to connect two components to each other, for example, a releasable connection that is easy to implement is provided. In addition, the plug connection is a self-centring connection, which may facilitate the connection of the two coupling portions, for example.

The bore and the plug further preferably have a cross-section that deviates from a circular shape, preferably an angular cross-section, further preferably a cross-section in the shape of a regular polygon, in particular a cross-section in the shape of a regular hexagon. In this way, it is possible, for example, to substantially prevent rotational movement of the plug in the bore, i.e. the holder relative to the eccentric hub or the shaking and mixing device, i.e. the connection is one that is secured against rotation. A regular polygon is herein understood to be a planar polygon that is both equilateral and equiangular. In a regular polygon, therefore, all sides are of equal length and all internal angles are of equal size.

Preferably, the plug has a cross-section whose cross-sectional area is slightly smaller than the cross-sectional area of a cross-section of the bore. The term “slightly smaller” means that the cross-sectional area of the plug is on the one hand small enough to fit into the bore, but on the other hand large enough to be provided in the bore essentially free of play, i.e. essentially without gaps. This enables, for example, a good, especially low-loss, transmission of force or transmission of movement from the eccentric hub to the holder.

Preferably, the bore comprises a widening section whose inner diameter is larger than the inner diameter of an adjacent bore section and wherein the plug also comprises a widening section whose outer diameter is larger than the outer diameter of an adjacent plug section, and wherein the widening section of the plug snaps into the widening section of the bore when the plug is inserted into the bore. Further preferably, the widening section of the plug is formed by an O-ring provided on the plug in the circumferential direction, preferably in a circumferential groove of the plug. The adjacent bore sections and/or plug sections are herein further preferably adjacent to each other along a bore axis or an axis of the plug, i.e. sections arranged next to each other. The widening sections thus form a force-fit connection between the plug and the bore or between the two coupling portions, respectively, in the axial direction. The widening sections make it possible, for example, to secure the plug against unintentional release from the bore, i.e. in the axial direction. To release the plug or remove the plug from the bore, for example, a defined axial force may be required to release the holder from the shaking and mixing device. An O-ring, in particular a flexible O-ring, for example formed of rubber, is for example an easy-to-implement embodiment of the widening section of the plug. Alternatively, the widening section of the plug may also be formed by a projection provided in the circumferential direction of the plug, which is preferably flexible to allow for passage of the projection of the plug through the narrower bore section before the projection engages in the widening section of the bore.

Preferably, the first coupling portion, the second coupling portion and the drive shaft have a common central axis when the first and second coupling portions are connected to each other. The central axis may, for example, be defined by an axis of rotation of the drive shaft. This may, for example, enable a good transmission of force from the drive to the holder. In this way, for example, an easy-to-implement connection is in addition provided which is provided as an extension of the drive shaft.

Further preferably, a middle axis of the holder is spaced apart or offset from the central axis, wherein the middle axis of the holder is even further preferably parallel to the central axis. This means that the central axis of the holder is not identical to the central axis of the coupling portions and the drive shaft. With this eccentric arrangement of the axes, for example, good mixing of the sample(s) may be achieved.

Preferably, the bore is provided at the first coupling portion, i.e. the eccentric hub or shaking and mixing device, and the plug is provided at the second coupling portion, i.e. the holder. This may, for example, make attachment of the holder to the shaking and mixing device easier.

Preferably, the first coupling portion is secured against rotation with respect to the eccentric hub. This may be realised, for example, by a non-releasable connection between the first coupling portion and the eccentric hub, e.g. by an adhesive connection, i.e. gluing the first coupling portion onto the eccentric hub. In this way, for example, a transmission of force from the eccentric hub to the holder may be improved.

Preferably, the first coupling portion is attached to and/or on the eccentric hub, further preferably non-detachably attached to the eccentric hub. A non-detachable attachment may for example be realised by gluing or soldering. A detachable fastening may, for example, be a screw connection. With such a releasable or non-releasable attachment, an already existing shaking and mixing device may, for example, be equipped or retrofitted with a releasable connection or the first coupling portion of the connection. Alternatively, the first coupling portion may be provided integral with the eccentric hub.

Preferably, the second coupling portion is provided on an adapter element connectable to the holder. The adapter element may be interchangeably provided on the holder or formed integrally therewith. An interchangeable adapter element may, for example, be usable with different holders so that a holder may, for example, be easily provided with the second coupling portion.

Further features and expediencies of the invention follow from the description of embodiments based on the accompanying drawings.

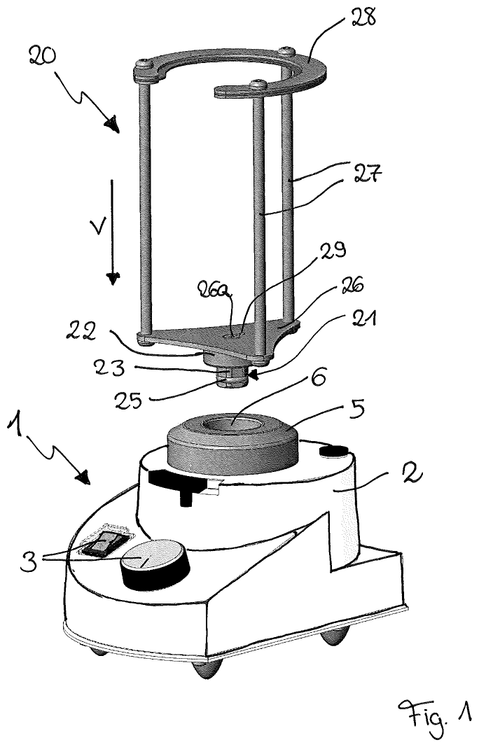

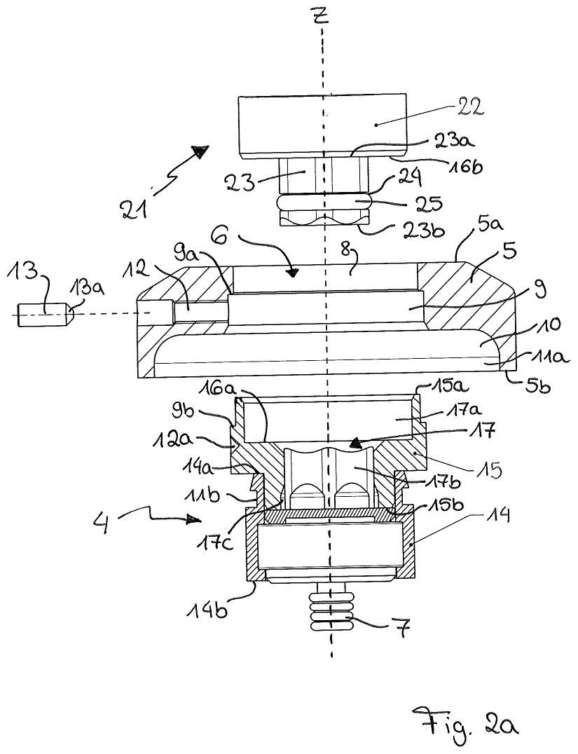

FIG. 1 is a schematic view of a shaking and mixing device according to one embodiment of the present invention with a holder for a sample container shown separately from the shaking and mixing device,

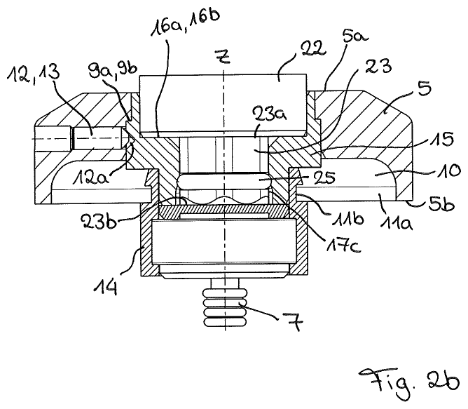

FIG. 2a is a schematic and sectional view of a portion of the shaking and mixing device shown in FIG. 1 and a portion of the holder,

FIG. 2b is a schematic and sectional view of the portions of the shaking and mixing device and the holder shown in FIG. 2a with the holder in place,

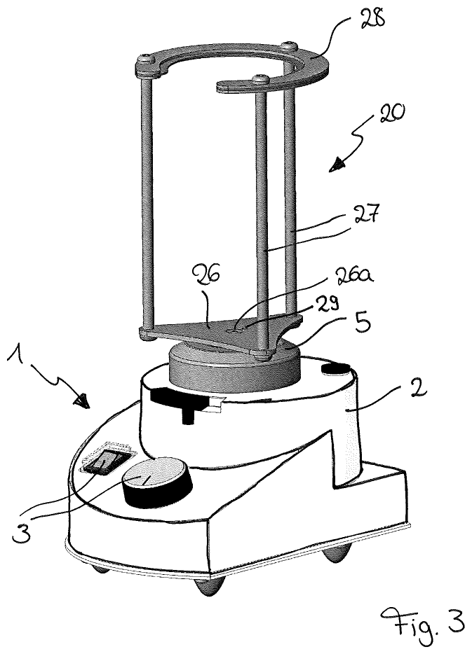

FIG. 3 is a schematic view of the shaking and mixing device shown in FIG. 1 with the holder in place, and

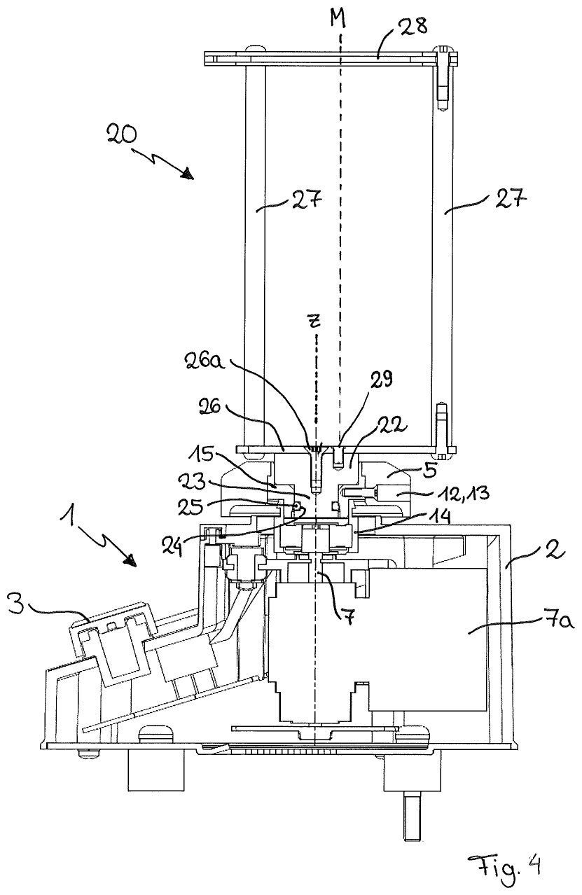

FIG. 4 is a schematic and sectional view of the shaking and mixing device shown in FIG. 3 with the holder in place.

An embodiment of the present invention is described below with reference to FIGS. 1 to 4. FIG. 1 shows a shaking and mixing device 1 having a housing 2 and a holder 20 for receiving one or more sample container(s) (not shown in the figures). In FIG. 1, the holder 20 is shown separately from the shaking and mixing device 1, i.e. not placed onto or connected to the shaking and mixing device 1. An adapter element 21 is provided at the bottom of the holder 20, i.e. at the side facing the shaking and mixing device.

Adjustment and/or control elements 3 are provided on the housing 2 for setting operating parameters of the shaking and mixing device 1, for example a frequency and/or amplitude of the shaking or mixing movement. Furthermore, a drive 7a (cf. Fig. FIG. 4), such as a motor, is provided in the housing 2 for driving an eccentric unit 4 (cf. FIG. 2a, 2b, 4) of the shaking and mixing device 1. The upper housing portion 5 that faces the holder 20 has a central recess 6 for receiving the adapter element 21 or at least its second coupling portion (see below). The upper housing portion 5 is preferably not formed integrally with the housing 2, but rather a separate housing portion which is attached to the housing 2 by means of a flexible attachment. The flexible attachment preferably allows certain movements of the upper housing portion 5, for example rocking, tumbling and/or vibrating movements, while it prevents other certain movements of the upper housing portion, for example twisting, and disengagement of the upper housing portion 5 from the housing 2.

The holder 20 shown in FIG. 1 comprises, purely by way of example, a triangular base plate 26 having a center of gravity 29 and three holding rods 27 spaced apart from each other and extending vertically upwardly, each of which is attached with its lower end to the corner of the triangular base plate 26. In the case of the holder 20 shown in FIG. 1, a medial axis M of the holder extends parallel to the extension direction of the holding rods 27, i.e. perpendicular to the base plate 26, through the center of gravity 29 of the base plate 26 (cf. FIG. 4). The upper ends of the holding rods 27 are connected to one another by means of a holding ring 28, which forms the upper boundary of the holder 20. The holding ring 28 shown in FIG. 1 comprises an opening between two of the holding rods 27 for introducing a sample container (not shown).

A sample container (not shown) can be introduced into the holder 20 such that it is supported by the holder 20. For example, the sample container can be placed on the base plate 26, the holding rods 27 preventing the sample container from shifting sideways. Alternatively, the sample container can also be placed in a hanging manner at the holding ring 28 within the holder 20. In this case, the holding ring 28 preferably comprises a clip which prevents unintentional detachment of the sample container.

An adapter element 21 is provided at the bottom of the base plate 26, i.e. on the side of the base plate 26 facing away from the holding rods 27. The adapter element 21 comprises a second coupling portion, which is designed as a plug 23, for releasably connecting the holder 20 to the shaking and mixing device 1 and an adapter portion 22 that connects the second coupling portion to the holder 20. The adapter portion 22 can be formed integrally with the holder 20. Alternatively, the adapter portion 22 can be attached to the holder 20 by means of a detachable attachment, for example a screw connection 26a shown schematically in FIG. 1, a plug connection, a magnetic connection, etc., or by means of a non-detachable attachment, for example by gluing, soldering, etc. For the holder 20 shown in the figures, the attachment or screw connection 26a of the adapter portion 22 to the holder 20 is not provided at the center of gravity 29 of the base plate 26, but offset from it.

The connection between the holder 20 and the shaking and mixing device 1 is described in more detail below with reference to FIGS. 2a and 2b and FIG. 4. FIGS. 2a and 2b each show a cross-sectional view of the eccentric unit 4 and of the upper housing portion 5 of the shaking and mixing device 1, as well as the adapter element 21. In FIG. 2a the eccentric unit 4, the upper housing portion 5 and the adapter element 21 are shown separately from one another and in FIG. 2b in an assembled state, i.e. connected to one another. FIG. 4 shows a cross-sectional view of the shaking and mixing device 1 with the holder 20 placed thereon.

The eccentric unit 4 is connected via a drive shaft 7 (only partially shown in FIGS. 2a, 2b) with the drive 7a (cf. FIG. 4) of the shaking and mixing device 1 and is driven by the drive during operation. A central axis Z is defined by the axis of rotation of the drive shaft 7.

The second coupling portion of the connection is provided at the adapter element 21 and is designed as a plug 23. The plug 23 extends from an upper or first end 23a to a lower or second end 23b, the first end 23a of the plug 23 being provided at the adapter portion 22 of the adapter element 21. A medial axis of the plug 23 from the first end 23a to the second end 23b corresponds to the central axis Z when the holder 20 is attached to the shaking and mixing device 1 (cf. Figs. FIG. 2b, 4). Perpendicular to the medial axis or the central axis Z, the plug 23 has a cross-section which has the shape of a regular hexagon through the center of which the medial axis or central axis Z runs.

Furthermore, a circumferential groove 24 is provided at the outside of the plug 23, into which groove an O-ring 25 is inserted. The O-ring 25 is preferably made of a resilient material, such as a rubber. The depth of the circumferential groove 24 and the thickness of the O-ring 25 are selected such that the O-ring 25 protrudes from the circumferential groove 24 in the radial direction. Thus, the O-ring forms a widening section of the plug 23, at which widening section the outer diameter of the plug is larger than the outer diameter of an adjacent plug section, i.e. the outer diameter of the plug above and below the widening section.

Perpendicular to the central axis Z the adapter portion 22 preferably has a larger radial extent, such as a larger diameter, than the plug 23 so that the adapter portion 22 has a projection 16b at its bottom, i.e. in the direction of the plug 23. The adapter portion 22 can, for example, be substantially cylindrical in shape with the central axis Z as the medial axis of the cylinder.

Furthermore, FIGS. 2a, 2b and 4 show the upper housing portion 5 having an upper or first end 5a and a lower or second end 5b. A medial axis of the upper housing portion 5 from the first end 5a to the second end 5b corresponds to the central axis Z (cf. FIG. 2b, 4). The central recess 6 of the upper housing portion 5 extends from the first end 5a to the second end 5b and thus forms a channel through the upper housing portion 5 along the central axis Z. As shown in FIG. 2a the central recess 6 essentially comprises three recess sections 8, 9, 10, wherein the upper recess section 8 is adjacent to the first end 5a of the upper housing portion 5, the lower recess section 10 is adjacent to the second end 5b of the upper housing portion 5 and the middle recess section 9 is provided between the upper recess section 8 and the lower recess section 10 along the central axis Z.

The recess sections 8, 9, 10 are each substantially cylindrical in shape with the central axis Z as the medial axis. The diameter of the upper recess section 8 perpendicular to the central axis Z is preferably adapted to an outer diameter of the first coupling portion 15 provided at the eccentric unit 4 (see below). Preferably, the diameter of the upper recess section 8 is slightly larger than the corresponding outer diameter of the first coupling portion 15 so that the first coupling portion 15 can be inserted into the upper recess section 8 (cf. FIG. 2b, 4) in a substantially form-fitting manner, i.e. substantially gap-free. The middle recess section 9 has a larger diameter than the upper recess section 8 so that a shoulder 9a is formed between the upper recess section 8 and the middle recess section 9.

The diameter of the lower recess section 10 is preferably adapted to the diameter of the eccentric hub 14 of the eccentric unit 4 (see below) perpendicular to the central axis Z. Preferably, the diameter of the lower recess section 10 is slightly larger than the diameter of the eccentric hub 14 so that the eccentric hub 14 can be inserted into the lower recess section 10 (cf. FIG. 2b, 4) in a substantially form-fitting manner, i.e. substantially gap-free. Furthermore, a projection 11a is formed at the wall of the lower recess section 10 in the circumferential direction, which projection protrudes into the recess 6.

At the axial height of the middle recess section 9, the upper housing portion 5 has a through-hole 12 extending horizontally, i.e. perpendicular to the central axis Z, from the outside of the upper housing portion 5 up to the recess 6. The through-hole 12 is designed to receive a pin 13 that has a tip 13a.

The eccentric unit 4 comprises an eccentric hub 14 having an upper or first end 14a and a lower or second end 14b of the eccentric hub 14. The second end 14b of the eccentric hub 14 is connected to the drive shaft 7. The eccentric hub 14 has a circumferential groove 11b at its outside, which central groove is designed to be complementary to the projection 11a of the lower recess section 10 in order to receive the projection 11a.

The first coupling portion 15 is provided on or at the eccentric hub 14, which first coupling portion at least partially protrudes beyond the first end 14a of the eccentric hub 14. The first coupling portion 15 is permanently connected to the eccentric hub 14 or provided integrally with the eccentric hub 14.

The first coupling portion 15 comprises an upper or first end 15a and a lower or second end 15b. As shown in FIGS. 2a, 2b and 4, the second end 15b of the first coupling portion 15 can be provided below the first end 14a of the eccentric hub 14. An axial bore 17 of the first coupling portion 15 extends from the first end 15a to the second end 15b of the first coupling portion 15, wherein a medial axis of the bore 17 corresponds to the central axis Z. The bore 17 comprises an upper bore section 17a that is adjacent to the first end 15a of the first coupling portion 15 and a lower bore section 17b that is adjacent to the second end 15b of the first coupling portion 15.

The upper bore section 17a has a substantially cylindrical shape, wherein the cross-section of the upper bore section 17a perpendicular to the central axis Z is designed complementary to the adapter portion 22, i.e. the diameter of the upper bore section 17a, and is slightly larger than the diameter of the adapter portion 22 so that the adapter portion 22 can be inserted into the upper bore section 17a substantially in a form-fitting manner, i.e. substantially gap-free (cf. FIGS. 2b, 4). The lower bore section 17b has a smaller diameter perpendicular to the central axis Z than the upper bore section 17a so that a shoulder 16a is formed between the upper bore section 17a and the lower bore section 17b, which shoulder is adjacent the projection 16b of the adapter portion when the adapter 21 is inserted (cf. FIGS. 2b, 4).

The lower bore section 17b has a geometrical shape which is designed complementary to the plug 23, i.e. perpendicular to the central axis Z the lower bore section 17b has a cross-section that has the shape of a regular hexagon, through the center of which the central axis Z extends. The cross-sectional area of the lower bore section 17b perpendicular to the central axis Z is slightly larger than the cross-sectional area of the plug 23 so that the plug 23 can be inserted into the lower bore section 17b in a substantially form-fitting manner, i.e. substantially gap-free (cf. FIG. 2b, 4). The plug 23 is thus secured against a rotation within the bore 17 (form-fitting connection in the radial direction, i.e. perpendicular to the central axis Z).

The upper bore section 17a has a length in the direction of the central axis Z which is at most as large as the length of the adapter portion 22 in the direction of the central axis Z. The lower bore section 17b has a length in the direction of the central axis Z which is as large as the length of the plug 23 in the direction of the central axis Z so that the plug 23 with its second end 23b abuts the bottom of the lower bore section 17b, i.e. the eccentric hub 14 (see below).

The lower bore section 17b comprises a widening section 17c adjacent to the second end 15b of the first coupling portion 15, the cross-sectional area of which widening section increases along the central axis Z towards the second end 15b. The widening section 17c is designed to receive the O-ring 25 of the second plug 23 when the plug 23 is inserted into the bore 17 so that the O-ring 25 snaps into the widening section 17c in order to secure the adapter element 21 upwardly in the axial direction within the first coupling portion 15 (force-fitting connection in the axial direction, i.e. parallel to the central axis Z). The bore 17, i.e. the widening section 17c is closed at the bottom by the eccentric hub 14.

At its outside, the first coupling portion 15 has a substantially cylindrical shape that is adapted to the shape of the upper recess section 8 and the middle recess section 9 of the upper housing portion 5 so that a projection 9b of the outside of the first coupling portion 15 is adjacent to the shoulder 9a of the recess 6 of the upper housing portion 5 in order to prevent the first coupling portion 15 from shifting axially upwards within the upper housing portion 5. Rotation of the first coupling portion with respect to the upper housing portion 5 is prevented by a blind hole 12a in the outside of the first coupling portion 15, which blind hole communicates with the through-hole 12 of the upper housing portion 5, i.e. forms an extension of the through-hole 12 in order to accommodate the tip 13a of the pin 13 guided through the through-hole 12 (cf. FIGS. 2b, 4).

The shaking and mixing device 1 is provided in a state in which the eccentric unit 4 with the first coupling portion 15 is arranged in the housing 2 and the upper housing portion 5 is attached to the eccentric unit 4 and the first coupling portion 15 (cf. FIGS. 2b, 4). In doing so, the eccentric groove 14 and the first coupling portion 15 attached to it are held in the upper housing portion 5 by the projection 9b of the first coupling portion 15, which projection abuts the shoulder 9a of the upper housing portion 5, and by the cooperation of the projection 11a of the upper housing portion 5 and the circumferential groove 11b of the eccentric groove 14 in the direction of the central axis Z, i.e. in the axial direction. Furthermore, the eccentric groove 14 and the first coupling portion 15 attached to it are secured against rotation in the upper housing portion 5 by the through-bore 12 and the blind hole 12a in cooperation with the pin 13 (cf. FIGS. 2b, 4).

For attaching the holder 20 to the shaking and mixing device 1, the holder 20 is guided downwards in the direction of the central axis Z, as schematically depicted by the arrow V in FIG. 1, so that the plug 23 is introduced into the bore 17 through the recess 6 of the upper housing portion 5 from the first end 15a until the O-ring 25 engages the widening section 17c and abuts the bottom of the bore 17, i.e. the eccentric hub 14. The resiliency of the O-ring 25 has the effect that the O-ring 25 is compressed in the circumferential groove 24 of the plug 23 in order to pass the narrower part of the bore section 17b and then expands again in the widening section 17c in order to prevent the plug 23 from shifting in the axial direction upwards out of the bore 17. A force-fit connection between the plug 23 and the bore 17 is thus formed in the axial direction. To release the connection, i.e. remove the holder 20 from the shaking and mixing device 1, accordingly a sufficiently large force in the axial direction upwards, i.e. in the direction of the first end 15a, is required which force has the effect that the O-ring is compressed again in the circumferential groove 24 in order to pass the narrower part of the bore section 17b.

In the assembled state shown in FIG. 2b, FIG. 3 and FIG. 4, i.e. when the holder 20 is held by the second coupling portion, i.e. the plug 23, in the first coupling portion 15, the plug 23 is held in the bore 17 in a form-fitting manner. This prevents a relative rotational movement between the plug 23 and the bore 17, i.e. a rotation of the plug 23 in the bore 17. The projection 16b of the adapter portion 22 in cooperation with the shoulder 16a of the first coupling portion 15, as well as the second end 23b of the plug 23 abutting the eccentric hub 14, result in a good transmission of force from the eccentric hub to the plug 23 and thus onto the holder 20.

FIG. 4 also shows the medial axis M of the holder 20, which medial axis passes through the center of gravity 29 of the base plate 26 and parallel to the central axis Z. The center of gravity 29 of the base plate 26 and thus also the medial axis M are arranged at a distance from the central axis Z on which the first and second coupling portions 15, 23, the drive shaft 7 and the attachment (screw connection 26a) that attaches the adapter portion 22 to the holder 20. This causes an eccentric movement of the holder 20 and thus also of the sample provided therein (not shown), which leads to thorough mixing of the sample.

Although in the embodiment described above with reference to FIGS. 1 to 4 the plug 23 of the plug connection is provided at the holder 20 and the bore 17, i.e. the socket of the plug connection is provided at the shaking and mixing device 1, the invention is not limited thereto. For example, the plug can also be provided at the shaking and mixing device 1 and the bore 17 at the holder 20. The connection described above does not need to be designed as a plug connection; rather, any other suitable detachable connection provided in extension of the drive shaft can be used to connect the holder and the shaking and mixing device, such as a screw connection.

Instead of the O-ring 25, an elastic or resilient projection can also be provided at the plug 23. This projection does not have to be formed along the entire circumference of the plug 23, but it can also be provided only partially or at one location along the circumference.

Furthermore, the shaking and mixing device can also be provided without the upper housing portion 5 or the upper housing portion 5 can be formed integrally with the housing 2.

1. A shaking and/or mixing device, comprising:
a drive having a drive shaft,
an eccentric unit driven by the drive shaft and having an eccentric hub, and
a holder for receiving at least one sample to be treated by the shaking and/or mixing device, wherein
the eccentric hub and the holder are connectable to one another by means of a releasable connection in order to transmit a movement of the eccentric hub onto the holder, the releasable connection being provided as an extension of the drive shaft.

2. The shaking and/or mixing device according to claim 1, wherein the eccentric hub comprises a first coupling portion of the releasable connection and the holder comprises a second coupling portion of the releasable connection and wherein the first and the second coupling portions are designed at least partially complementary with respect to their geometric shape.

3. The shaking and/or mixing device according to claim 2, wherein one of the two coupling portions comprises at least one bore and the other one of the two coupling portions comprises at least one plug which can be inserted into the bore and is designed complementary to the bore.

4. The shaking and/or mixing device according to claim 3, wherein the bore and the plug have a cross-section that deviates from a circular shape, preferably an angular cross-section, further preferably a cross-section in the shape of a regular polygon, in particular a regular hexagon.

5. The shaking and/or mixing device according to claim 3, wherein the plug has a cross-section whose cross-sectional area is slightly smaller than the cross-sectional area of a cross-section of the bore.

6. The shaking and/or mixing device according to claim 2, wherein the bore comprises a widening section whose inner diameter is greater than the inner diameter of an adjacent bore section, and wherein the plug also comprises a widening section whose outer diameter is larger than the outer diameter of an adjacent plug section and wherein the widening section of the plug snaps into the widening section of the bore when the plug is inserted into the bore.

7. The shaking and/or mixing device according to claim 6, wherein the widening section of the plug is formed by an O-ring provided on the plug in the circumferential direction, preferably within a circumferential groove of the plug.

8. The shaking and/or mixing device according to claim 2, wherein the first coupling portion, the second coupling portion and the drive shaft have a common central axis when the first and second coupling portions are connected to one another.

9. The shaking and/or mixing device according to claim 2, wherein the bore is provided at the first coupling portion and the plug is provided at the second coupling portion.

10. The shaking and/or mixing device according to claim 2, wherein the first coupling portion is secured against a rotation with respect to the eccentric hub.

11. The shaking and/or mixing device according to claim 2, wherein the first coupling portion is attached on the eccentric hub, preferably non-releasably fixed on the eccentric hub.

12. The shaking and/or mixing device according to claim 2, wherein the second coupling portion is provided on an adapter element connectable to the holder.
